(19) United States
(12) Patent Application Publication
(10) Pub. No.: US 2023/0233884 A1
(43) Pub. Date: Jul. 27, 2023

(54) Task Mask Device

(71) Applicant: Nicholas Ginther, Fort Wayne, IN (US)

(72) Inventor: Nicholas Ginther, Fort Wayne, IN (US)

(21) Appl. No.: 17/937,520

(22) Filed: Oct. 3, 2022

Related U.S. Application Data
(60) Provisional application No. 63/301,674, filed on Jan. 21, 2022.

(51) Int. Cl. A62B 18/04; A41D 13/11; A42B 3/20; A62B 18/08; A62B 23/02

(52) U.S. Cl. CPC A62B 18/04; A41D 13/11; A42B 3/20; A62B 18/08; A62B 18/084; A62B 23/02

(57) ABSTRACT

The present invention relates to a novel face mask shield device. The device is designed to fully encapsulate the eyes, nose, mouth, and ears of a user, while working in hazardous material environments. The device comprises a protective mask component, an attached headlamp, a detachable respirator filter, and detachable earmuffs with high decibel noise cancelling ability. The face mask shield device is powered by regular batteries or by a 12 v rechargeable battery. The face mask shield device keeps the user safe while working, remaining in place and offering comfortable wear for long periods of time.

### CROSS-REFERENCE TO RELATED APPLICATION

The present application claims priority to, and the benefit of, U.S. Provisional Application No. 63/301,674, which was filed on Jan. 21, 2022 and is incorporated herein by reference in its entirety.

### FIELD OF THE INVENTION

The present invention relates generally to the field of personal protective equipment (PPE). More specifically, the present invention relates to an improved face mask shield device that provides users with protection from flying debris and other contaminants. Accordingly, the present disclosure makes specific reference thereto. Nonetheless, it is to be appreciated that aspects of the present invention are also equally applicable to other like applications, devices and methods of manufacture.

### BACKGROUND

By way of background, personal protective equipment (PPE) is important in many different jobs. For example, healthcare workers, construction workers, and other workplace environments require face masks to protect workers from flying debris, splattered liquids, and other contaminants.

However, wearing face masks and shields in workplace environments can be extremely frustrating and uncomfortable. For example, many standard face mask shields need to be constantly adjusted to keep them in place on a user's face, taking away the user's attention from the task at hand. Further, stopping to replace and/or adjust a face mask shield can be frustrating and time consuming. Additionally, some users may require eyeglasses to be worn under the face mask shield, and/or may require a clear, unobstructed view when wearing the face mask shield. Some face mask shields may be uncomfortable, causing skin irritation due to long periods of wear. Thus, a face mask shield that easily and comfortably shields a user's face, even if eyeglasses are worn under the shield, and is adaptable to a variety of different users, and permits a clear and full view therethrough and permits use alone or in combination with a hat, would be advantageous.

Thus, it is necessary for users who work in various workplace environments, where contaminants and debris are likely, to have a more comfortable and efficient face mask shield which protects the user and is adaptable to a variety of different users. Generally, wearing face mask shields can be irritating and uncomfortable, however some workplace environments require such face mask shields. Therefore, users require a face mask shield device that is comfortable and non-irritating to wear for extended periods of time.

Therefore, there exists a long-felt need in the art for a face mask shield device that provides users with an improved safety mask used to protect the eyes, ears, and face of the user while working. There is also a long-felt need in the art for a face mask shield device that enables users to maintain proper safety in hazardous environments. Further, there is a long-felt need in the art for a face mask shield device that provides a safe mask without worry of the personal protective equipment moving out of place or requiring a replacement while working. Moreover, there is a long-felt need in the art for a device that includes multiple features like respiratory filters, detachable earmuffs, a headlamp, a durable transparent visor, etc., to keep the user protected against loud noises and flying debris. Further, there is a long-felt need in the art for a face mask shield device that features a connected armband to store batteries, allowing for replacement batteries while remaining in the work area. Finally, there is a long-felt need in the art for a face mask shield device that improves visibility in lowlight areas via the integrated LED lights above the visor.

The subject matter disclosed and claimed herein, in one embodiment thereof, comprises a face mask shield device. The device is designed to fully encapsulate the eyes, nose, mouth, and ears of a user, while working in hazardous material environments. The device comprises a protective mask component, an attached headlamp, a detachable respirator filter, and detachable earmuffs with high decibel noise cancelling ability. The face mask shield device is powered by regular batteries or by a 12 v rechargeable battery. The battery can be secured to the protective mask component via an armband. Users can breathe comfortably through the mask while harmful particulates are filtered out via the respiratory filters. The face mask shield device keeps the user safe while working, remaining in place and offering comfortable wear for long periods of time.

In this manner, the face mask shield device of the present invention accomplishes all of the foregoing objectives and provides users with a device that enables users to maintain proper safety in hazardous environments. The device allows a user to not worry that their PPE will move out of place or require a replacement while in use. The device provides a face mask shield device that is comfortable and non-irritating to wear for extended periods of time.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a face mask shield device. The device is designed to fully encapsulate the eyes, nose, mouth, and ears of a user, while working in hazardous material environments. The device comprises a protective mask component, an attached headlamp, a detachable respirator filter, and detachable earmuffs with high decibel noise cancelling ability. Users can breathe comfortably through the mask while harmful particulates are filtered out via the respiratory filters. The face mask shield device keeps the user safe while working, remaining in place and offering comfortable wear for long periods of time.

In one embodiment, the protective mask component of the face mask shield device comprises a flexible fluid impervious transparent face protector, and a plurality of fasteners. The protector is sized to cover the entire face of a user. Specifically, it is an aim of the present invention to provide a face mask shield device that covers the user's eyes, ears, nose, and mouth. To accomplish this, the face protector extends around a user's jaw and back toward a user's ears, and up over a user's nose and eyes towards their forehead. The protector can be one integral piece formed to secure around a user's face, according to the contours of a human's face or formed in a visor shape, wherein the top of the protector is preferably flat and the bottom of the protector is preferably curved. Further, the face protector comprises perforations, slits or through holes, near the nose and mouth areas, such that a user can breathe through the protector, and/or perforations, slits or through holes, near the ear area, such that a user can hear through the protector. Further, the perforations provided around the mouth area can further assist in preventing fogging of the protector and increasing comfort of the user. Additionally, all of the perforations can be angled downwardly to further assist in preventing any liquid material from passing therethrough and contacting the user's face and/or ears.

In one embodiment, the protective mask component comprises a plurality of protective layers. The plurality of protective layers work together to block airborne aerosol of hazardous biological agents (such as bacteria or viruses) and protect the user from electromagnetic radiation at the same time. In other words, the protective layers are antibacterial, antiviral, and act as a barrier for electromagnetic radiation. Furthermore, the protective mask component may comprise a single layer or multi-layer having dimensions big enough to cover the mouth, nose, ear and eye region of a user. Thus, the protective mask component may comprise any number or layers, shape, size, components, and arrangement of components that are known to one of ordinary skill in the art, as long as the intents of the present invention are not altered.

In one embodiment, the face protector comprises a skin friendly layer or coating. The inner layer or coating is adapted to come into direct contact with the user's skin, and thus should be made from a skin-friendly material or coating. However, it should be noted that other suitable materials or coatings are also contemplated.

In one embodiment, the face protector is held in place by a plurality of fasteners mounted to terminal edges of the protective mask component, wherein the plurality of fasteners are configured to hold the face mask shield device in place. This is so that the plurality of fasteners does not hinder the functionality of the face mask shield device, as well as does not cause any discomfort to the user's face. In the preferred embodiment, the plurality of fasteners may be manufactured in many forms. Examples of such fasteners include, but are not limited to, elastic straps, hook and loop fasteners, snap clip, magnetic fasteners, etc. However, it should be noted that the plurality of fasteners may comprise any other fastener kind or fastening technology that are known to one of ordinary skill in the art, as long as the objectives of the present invention are fulfilled.

In one embodiment, the face protector is removably attached to the peripheral edge of a helmet or hard hat, such that the face protector extends over the user's ears and forehead. A variety of known attachment mechanisms including adhesive, Velcro and snaps could be used to attach the face protector. In this manner, if the face protector becomes spattered or damaged it can easily be removed to be cleaned or replaced with another protector and not require the entire device to be disposed of. In another embodiment, the protector is permanently secured to the helmet or hard hat via glue, molding, etc., to form one integral piece. Further, the protector is attached to the outer edge of the helmet and is spaced sufficiently away from the user's face to comfortably accommodate eyeglasses and/or a breathing apparatus, to further assist in preventing fogging of the protector and yet still provide protection from debris.

In one embodiment, the helmet also features a visor that tapers from a minimum value near the temples of the user to a maximum width at approximately the midpoint of the user's forehead when the protector is in use. Although the maximum width of the visor can vary depending upon the particular application for the present invention, widths around at least 1.5 inches have been found most preferable.

The helmet is designed to follow the contour of the user's head. A portion of the inner edge of the helmet is provided with an absorbent cushioning material. The cushioning material forms a sponge-like cushion-fitted padding contoured to the shape of the peripheral of the user's head. This allows a snug fit about the forehead of the user to keep any gaps from forming between the user's forehead and the face protector through which spatters and debris might otherwise travel. The absorbency of the material also serves to prevent slippage of the face protector due to perspiration on the user's forehead.

A variety of different securing means can be used to attach the cushioning material to the inner edge, such as adhesives, Velcro, etc. Although the material is usually of a uniform thickness, the resiliency of the cushioning material allows it to be adjusted to have a slightly differing thickness along its length if this is necessary to accommodate the user's forehead.

In one embodiment, the helmet comprises a headlamp positioned above the visor. The headlamp is battery powered and controlled by the user. The headlamp is typically an LED but can be any suitable headlamp as is known in the art. Any number of headlamps can be utilized depending on the needs and/wants of a user.

In one embodiment, the face mask shield device is powered via batteries. Typically, the device is powered via regular batteries which must be replaced as needed. However, in one embodiment, the device can be powered via rechargeable batteries. Typically, the rechargeable batteries are 12 v batteries, such as those compatible with power tools. After use, the rechargeable batteries are removed and recharged as needed. In one embodiment, the battery compartment can be positioned on the helmet. In another embodiment, the battery compartment is secured within an armband worn by the user. The batteries are in communication with the device via wiring from the device to the armband.

In one embodiment, the protective mask component comprises a detachable respirator filter that can be secured at the mouth area of the user. The respirator filter comprises charcoal or other filtering material that prevents particles or other contaminants from passing therethrough, while allowing an exchange of air and perhaps vapor. In a preferred embodiment, the respirator filter is detachable and replaceable, as needed. In a further embodiment, the filter may be a lighter dust mask type filter for providing protection from lesser hazards and increased comfort, and may further comprise an adhering or sealing capability to adhere the mask to the face of the wearer for increased protection. In yet another embodiment, the protective mask component may comprise active noise cancelling earmuffs.

In one embodiment, the protective mask component comprises a pair of detachable earmuffs that can be secured at the ear area of the user. Specifically, an earmuff is formed on the ear-covering portion of the protective mask component, wherein each earmuff is secured together via a headband component, such that the earmuffs do not slide down during use or become dislodged/removed. The earmuffs are detachable and include both high and low decibel noise canceling ability, thereby protecting a user from noises from the worksite.

Further, the detachable respirator filter and earmuffs may be removably attached to the protective mask component, such that the respirator filter and earmuffs may be used as an additional protective device to any existing facemasks.

In one embodiment, the face protector is constructed of transparent flexible plastic or similar material. It preferably includes a chemical coating to prevent glare.

In another embodiment, the face protector is removably or permanently attached to a helmet or hard hat. The helmet or hard hat can be formed of plastic or high impact styrene plastic molded into a helmet form.

In yet another embodiment, the face protector and the helmet from the face mask shield device is manufactured from a material that is water resistant.

In another embodiment, the face mask shield device comprises a plurality of indicia on the helmet and/or the face protector.

In yet another embodiment, a method of protecting a user from flying debris and other contaminants in a workplace environment is described. The method includes the steps of providing a face mask shield device comprising a protective mask that fully encapsulates the eyes, nose, mouth, and ears while working in hazardous material environments. The method also comprises securing the face mask shield device to a user's face area. Further, the method comprises securing a detachable respirator filter and detachable earmuffs to the device if needed. The method also comprises utilizing the face mask shield device in a hazardous material environment. Finally, recharging the batteries after use of the face mask shield device if needed.

In yet another embodiment of the present invention, a face mask shield device is disclosed for enabling users to maintain proper safety in hazardous environments. The device comprises a protective mask component that fully encapsulates the eyes, nose, mouth, and ears of a user. The device further comprises an attached headlamp, a detachable respirator filter, and detachable earmuffs with high decibel noise cancelling ability. Users can breathe comfortably through the mask while harmful particulates are filtered out via the respiratory filters. The face mask shield device keeps the user safe while working, remaining in place and offering comfortable wear for long periods of time.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the face mask shield device of the present invention in use in accordance with the disclosed architecture;

FIG. 2 illustrates a perspective view of one potential embodiment of the face mask shield device of the present invention in accordance with the disclosed architecture;

FIG. 3 illustrates a perspective view of one potential embodiment of the face mask shield device of the present invention disclosing the attached headlamp in accordance with the disclosed architecture;

FIG. 4 illustrates a perspective view of one potential embodiment of the face mask shield device of the present invention disclosing the respiratory filter in accordance with the disclosed architecture;

FIG. 5 illustrates a perspective view of one potential embodiment of the face mask shield device of the present invention disclosing the detachable earmuffs in accordance with the disclosed architecture; and

FIG. 6 illustrates a flowchart showing the method of using one potential embodiment of the face mask shield device of the present invention to protect a user from flying debris and other contaminants in a workplace environment in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a face mask shield device that provides users with an improved safety mask used to protect the eyes, ears, and face of the user while working. There is also a long-felt need in the art for a face mask shield device that enables users to maintain proper safety in hazardous environments. Further, there is a long-felt need in the art for a face mask shield device that provides a safe mask without worry of the personal protective equipment moving out of place or requiring a replacement while working. Moreover, there is a long-felt need in the art for a device that includes multiple features like respiratory filters, detachable earmuffs, a headlamp, a durable transparent visor, etc., to keep the user protected against loud noises and flying debris. Further, there is a long-felt need in the art for a face mask shield device that features a connected armband to store batteries, allowing for replacement batteries while remaining in the work area. Finally, there is a long-felt need in the art for a face mask shield device that improves visibility in lowlight areas via the integrated LED lights above the visor.

The present invention, in one exemplary embodiment, is a novel face mask shield device. The device is designed to fully encapsulate the eyes, nose, mouth, and ears of a user, while working in hazardous material environments. The device comprises a protective mask component, an attached headlamp, a detachable respirator filter, and detachable earmuffs with high decibel noise cancelling ability. The face mask shield device is powered by regular batteries or by a 12 v rechargeable battery. The present invention also includes a novel method of protecting a user from flying debris and other contaminants in a workplace environment. The method includes the steps of providing a face mask shield device comprising a protective mask that fully encapsulates the eyes, nose, mouth, and ears while working in hazardous material environments. The method also comprises securing the face mask shield device to a user's face area. Further, the method comprises securing a detachable respirator filter and detachable earmuffs to the device if needed. The method also comprises utilizing the face mask shield device in a hazardous material environment. Finally, recharging the batteries after use of the face mask shield device if needed.

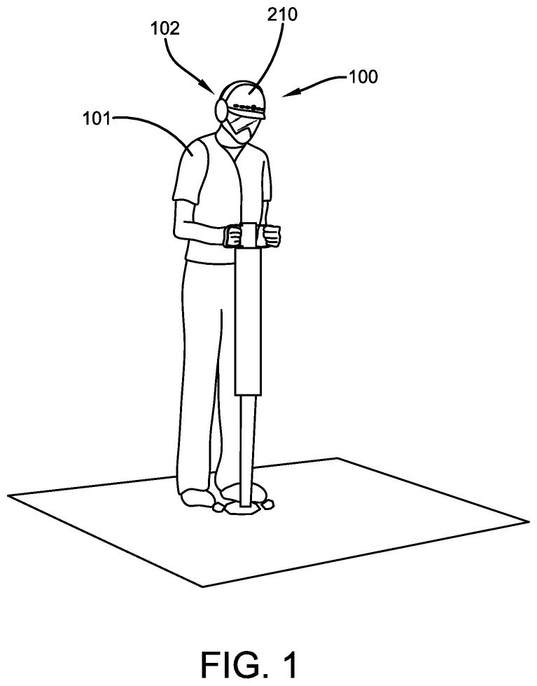

Referring initially to the drawings, FIG. 1 illustrates a perspective view of one embodiment of the face mask shield device 100 of the present invention in use. In the present embodiment, the face mask shield device 100 is an improved face mask shield device that provides a face mask shield device that is comfortable and non-irritating to wear for extended periods of time. The device 100 is especially designed to allow any healthcare worker, construction worker, or other hazardous materials worker, etc., or any other suitable user 101 as is known in the art, to be protected in hazardous work environments. More specifically, the device 100 comprises a protective mask component 102 designed to fully encapsulate the eyes, nose, mouth, and ears of a user 101. The protective mask component 102 comprises an attached headlamp 104, a detachable respirator filter 106, and detachable earmuffs 108 with high decibel noise cancelling ability. Users can breathe comfortably through the mask device 100 while harmful particulates are filtered out via the respiratory filters 106. The face mask shield device 100 keeps the user 101 safe while working, remaining in place and offering comfortable wear for long periods of time.

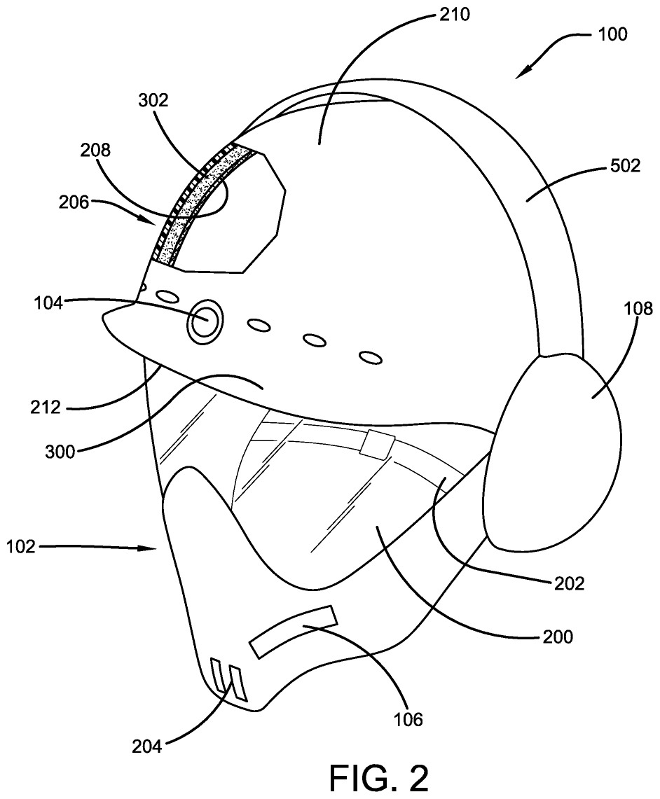

FIG. 2 illustrates a perspective view of another embodiment of the face mask shield device 100 of the present invention. In this embodiment, the protective mask component 102 of the face mask shield device 100 comprises a flexible fluid impervious transparent face protector 200, and a plurality of fasteners 202. The protector 200 is sized to cover the entire face of a user 101. Specifically, it is an aim of the present invention to provide a face mask shield device 100 that covers the user's eyes, ears, nose, and mouth. To accomplish this, the face protector 200 extends around a user's jaw and back toward a user's ears, and up over a user's nose and eyes towards their forehead. The protector 200 can be one integral piece formed to secure around a user's face, according to the contours of a human's face or formed in a visor shape, wherein the top of the protector 200 is preferably flat and the bottom of the protector 200 is preferably curved. Further, the face protector 200 comprises perforations 204, slits or through holes, near the nose and mouth areas, such that a user 101 can breathe through the protector 200, and/or perforations 204, slits or through holes, near the ear area, such that user 101 can hear through the protector 200. Further, the perforations 204 provided around the mouth area can further assist in preventing fogging of the protector 200 and increasing comfort of the user 101. Additionally, all of the perforations 204 can be angled downwardly to further assist in preventing any liquid material from passing therethrough and contacting the user's face and/or ears.

In one embodiment, the protective mask component 102 comprises a plurality of protective layers 206. The plurality of protective layers 206 works together to block airborne aerosol of hazardous biological agents (such as bacteria or viruses) and protect the user 101 from electromagnetic radiation at the same time. In other words, the protective layers 206 are antibacterial, antiviral, and act as a barrier for electromagnetic radiation. Furthermore, the protective mask component 102 may comprise a single layer or multi-layer having dimensions big enough to cover the mouth, nose, ear and eye region of a user 101. Thus, the protective mask component 102 may comprise any number or layers, shape, size, components, and arrangement of components that are known to one of ordinary skill in the art, as long as the intents of the present invention are not altered.

In another embodiment, the face protector 200 comprises a skin friendly layer or coating 208. The inner layer or coating 208 is adapted to come into direct contact with the user's skin, and thus should be made from a skin-friendly material or coating. However, it should be noted that other suitable materials or coatings are also contemplated as is known in the art.

Additionally, the face protector 200 is held in place by a plurality of fasteners 202 mounted to terminal edges of the protective mask component 102, wherein the plurality of fasteners 202 are configured to hold the face mask shield device 100 in place. This is so that the plurality of fasteners 202 does not hinder the functionality of the face mask shield device 100, as well as does not cause any discomfort to the user's face. In the preferred embodiment, the plurality of fasteners 202 may be manufactured in many forms. Examples of such fasteners 202 include, but are not limited to, elastic straps, hook and loop fasteners, snap clip, magnetic fasteners, etc. However, it should be noted that the plurality of fasteners 202 may comprise any other fastener kind or fastening technology that are known to one of ordinary skill in the art, as long as the objectives of the present invention are fulfilled.

Furthermore, the face protector 200 is removably attached to the peripheral edge 212 of a helmet or hard hat 210, such that the face protector 200 extends over the user's ears and forehead. A variety of known attachment mechanisms including adhesive, Velcro and snaps could be used to attach the face protector 200. In this manner, if the face protector 200 becomes spattered or damaged it can easily be removed to be cleaned or replaced with another protector 200 and not require the entire device 100 to be disposed of. In another embodiment, the protector 200 is permanently secured to the helmet or hard hat 210 via glue, molding, etc., to form one integral piece. Further, the protector 200 is attached to the outer peripheral edge 212 of the helmet 210 and is spaced sufficiently away from the user's face to comfortably accommodate eyeglasses and/or a breathing apparatus, to further assist in preventing fogging of the protector 200 and yet still provide protection from debris.

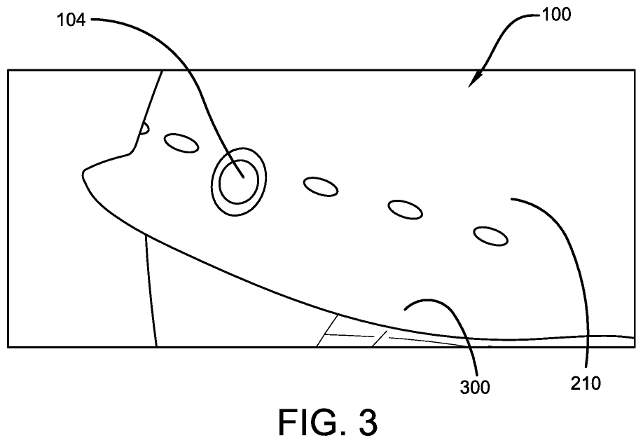

FIG. 3 illustrates a perspective view of another embodiment of the face mask shield device 100 of the present invention. In this embodiment, the helmet 210 also features a visor 300 that tapers from a minimum value near the temples of the user to a maximum width at approximately the midpoint of the user's forehead when the protector 200 is in use. Although the maximum width of the visor 300 can vary depending upon the particular application for the present invention, widths around at least 1.5 inches have been found most preferable.

Additionally, the helmet 210 is designed to follow the contour of the user's head. A portion of the inner edge of the helmet 210 is provided with an absorbent cushioning material 302. The cushioning material 302 forms a sponge-like cushion-fitted padding contoured to the shape of the peripheral of the user's head. This allows a snug fit about the forehead of the user 101 to keep any gaps from forming between the user's forehead and the face protector 200 through which spatters and debris might otherwise travel. The absorbency of the material 302 also serves to prevent slippage of the face protector 200 due to perspiration on the user's forehead.

Further, a variety of different securing means can be used to attach the cushioning material 302 to the inner edge, such as adhesives, Velcro, etc. Although the material 302 is usually of a uniform thickness, the resiliency of the cushioning material 302 allows it to be adjusted to have a slightly differing thickness along its length if this is necessary to accommodate the user's forehead.

Additionally, the helmet 210 comprises a headlamp 104 positioned above the visor 300. The headlamp 104 is battery powered and controlled by the user 101. The headlamp 104 is typically an LED but can be any suitable headlamp 104 as is known in the art. Any number of headlamps 104 can be utilized depending on the needs and/wants of a user 101.

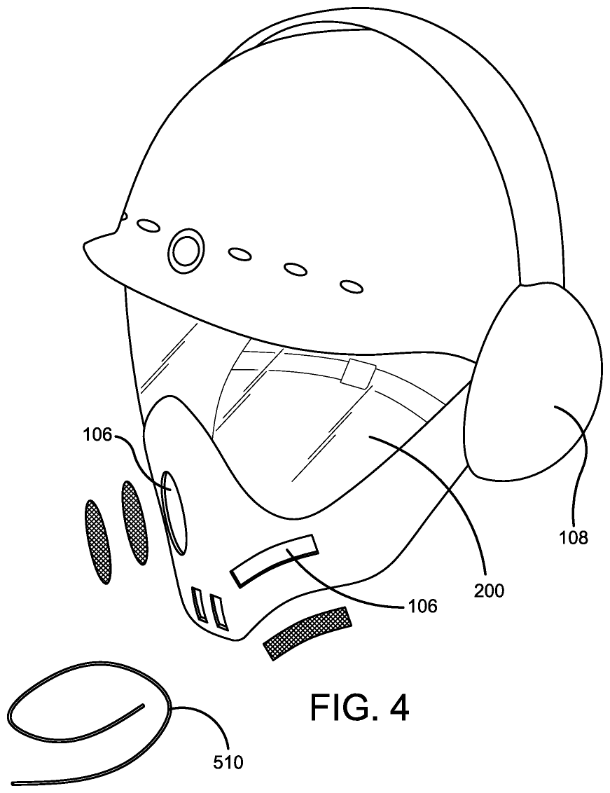

FIG. 4 illustrates a perspective view of another embodiment of the face mask shield device 100 of the present invention. In this embodiment, the protective mask component 102 comprises a detachable respirator filter 106 that can be secured at the mouth area of the user 101. The respirator filter 106 comprises charcoal or other filtering material that prevents particles or other contaminants from passing therethrough, while allowing an exchange of air and perhaps vapor. In a preferred embodiment, the respirator filter 106 is detachable and replaceable, as needed. Any suitable respirator filter 106 can be utilized as is known in the art, depending on the needs and/or wants of a user.

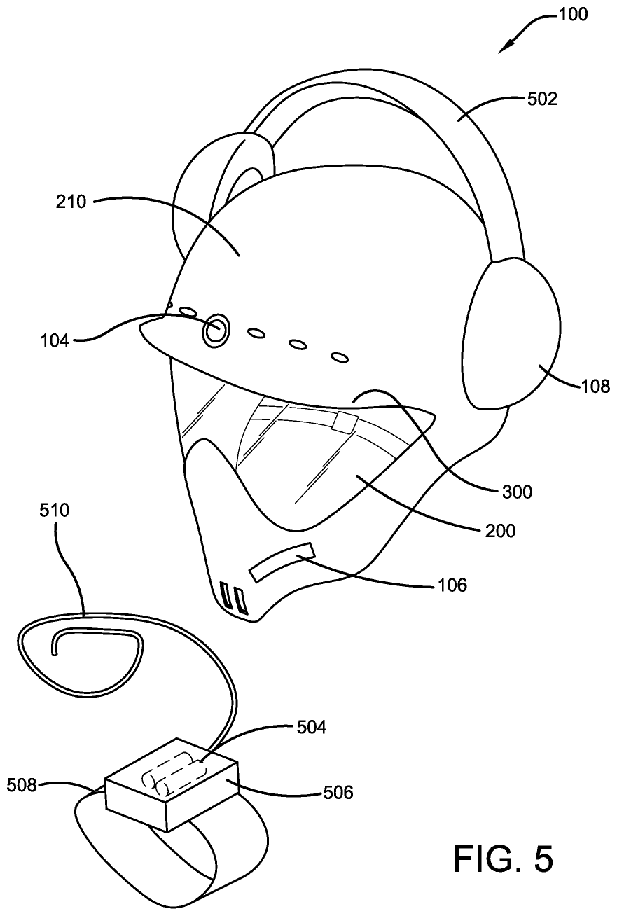

FIG. 5 illustrates a perspective view of another embodiment of the face mask shield device 100 of the present invention. In this embodiment, the protective mask component 102 comprises a pair of detachable earmuffs 108 that can be secured at the ear area of the user 101. Specifically, an earmuff 108 is formed on the ear-covering portion of the protective mask component 102, wherein each earmuff 108 is secured together via a headband component 502 or other suitable securing means, such that the earmuffs 108 do not slide down during use or become dislodged/removed. The earmuffs 108 are detachable and include high decibel noise canceling ability, protecting a user 101 from loud noises on the worksite. Any suitable earmuff 108 can be utilized as is known in the art, depending on the needs and/or wants of a user.

Further, the detachable respirator filter 106 and earmuffs 108 may be removably attached to the protective mask component 102, such that the respirator filter 106 and earmuffs 108 may be used as an additional protective device to any existing facemasks.

Furthermore, the face mask shield device 100 is powered via batteries 504. Typically, the device 100 is powered via regular batteries which must be replaced as needed. However, in one embodiment, the device can be powered via rechargeable batteries. Typically, the rechargeable batteries are 12 v batteries, such as those compatible with power tools. After use, the rechargeable batteries are removed and recharged as needed. In one embodiment, the battery compartment 506 can be positioned on the helmet 210. In another embodiment, the battery compartment 506 is secured within an armband 508 worn by the user 101. The batteries 504 are in communication with the device 100 via wiring 510 from the device 101 to the armband 508.

In one embodiment, the face protector 200 is constructed of transparent flexible plastic or similar material, or any other suitable material as is known in the art. It preferably includes a chemical coating to prevent glare. In another embodiment, the face protector 200 is removably or permanently attached to a helmet or hard hat 210. The helmet or hard hat 210 can be formed of plastic or high impact styrene plastic, or any other suitable material as is known in the art, molded into a helmet form. Furthermore, the face protector 200 and the helmet 210 from the face mask shield device 100 is manufactured from a material that is water resistant or water permeable, or the comprises a coating that is water resistant or water permeable.

In another embodiment, the face mask shield device 100 comprises a plurality of indicia 512 on the helmet 210 and/or the face protector 200. Specifically, the device 100 may include advertising, a trademark, or other letters, designs, or characters, printed, painted, stamped, or integrated into the helmet 210 and/or the face protector 200, or any other indicia 512 as is known in the art. Specifically, any suitable indicia 512 as is known in the art can be included, such as, but not limited to, patterns, logos, emblems, images, symbols, designs, letters, words, characters, animals, advertisements, brands, etc., that may or may not be facemask or brand related.

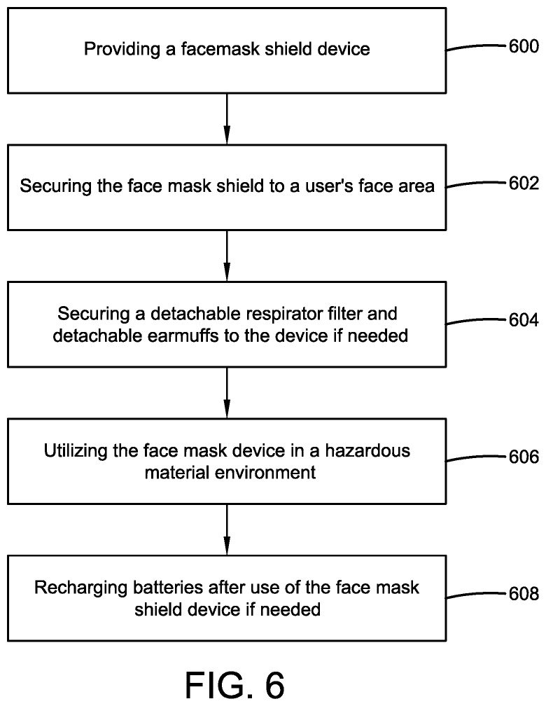

FIG. 6 illustrates a flowchart of the method of protecting a user from flying debris and other contaminants in a workplace environment. The method includes the steps of at 600, providing a face mask shield device comprising a protective mask that fully encapsulates the eyes, nose, mouth, and ears while working in hazardous material environments. The method also comprises at 602, securing the face mask shield device to a user's face area. Further, the method comprises at 604, securing a detachable respirator filter and detachable earmuffs to the device if needed. The method also comprises at 606, utilizing the face mask shield device in a hazardous material environment. Finally, at 608, recharging the batteries after use of the face mask shield device if needed.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “face mask shield device”, “face mask device”, and “device” are interchangeable and refer to the face mask shield device 100 of the present invention.

Notwithstanding the foregoing, the face mask shield device 100 of the present invention can be of any suitable size and configuration as is known in the art without affecting the overall concept of the invention, provided that it accomplishes the above stated objectives. One of ordinary skill in the art will appreciate that the face mask shield device 100 as shown in FIGS. 1-6 is for illustrative purposes only, and that many other sizes and shapes of the face mask shield device 100 are well within the scope of the present disclosure. Although the dimensions of the face mask shield device 100 are important design parameters for user convenience, the face mask shield device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A face mask shield device that is comfortable and non-irritating to wear for an extended period of time, the face mask shield device comprising:
a protective mask component comprising a detachable respirator filter that can be secured adjacent a mouth area of a user; and
a battery;
wherein the protective mask component further comprises a face protector and a plurality of fasteners; and
further wherein the face protector is sized to cover an entire face of the user.

2. The face mask shield device of claim 1, wherein the face protector is comprised of a transparent and a fluid impervious material.

3. The face mask shield device of claim 2, wherein the face protector covers a user's eyes, ears, nose and the mouth area.

4. The face mask shield device of claim 3, wherein the face protector comprises a plurality of perforations around the mouth area and an ear area of the user.

5. The face mask shield device of claim 1, wherein the protective mask component comprises a plurality of protective layers.

6. The face mask shield device of claim 1, wherein the face protector comprises a skin friendly layer.

7. The face mask shield device of claim 1, wherein the face protector is secured to a peripheral edge of a helmet.

8. The face mask shield device of claim 7, wherein the helmet comprises a visor.

9. The face mask shield device of claim 8, wherein the helmet comprises an inner edge of an absorbent cushioning material.

10. The face mask shield device of claim 9, wherein the helmet comprises a headlamp positioned above the visor.

11. The face mask shield device of claim 10, wherein the headlamp is an LED.

12. The face mask shield device of claim 11, wherein the protective mask component comprises a pair of detachable earmuffs.

13. The face mask shield device of claim 1 further comprising a plurality of indicia.

14. A face mask shield device that is comfortable and non-irritating to wear for an extended period of time, the face mask shield device comprising:
a protective mask component comprising:
a detachable respirator filter that can be secured adjacent a mouth area of a user;
a pair of detachable earmuffs secured adjacent an ear area of the user;
a face protector sized to cover an entire face of the user; and
a plurality of fasteners;
wherein the face protector is secured to a peripheral edge of a helmet;
wherein the helmet comprises a headlamp; and
further wherein the face mask shield device is powered via a rechargeable battery with a battery compartment secured within an armband worn by the user.

15. The face mask shield device of claim 14, wherein the helmet comprises a visor.

16. The face mask shield device of claim 14, wherein the headlamp is an LED.

17. The face mask shield device of claim 14, wherein the face protector comprises a plurality of perforations around the mouth area and the ear area of the user.

18. The face mask shield device of claim 14 further comprising a plurality of indicia.

19. The face mask shield device of claim 14, wherein the face protector is comprised of a material that is both transparent and fluid impervious.

20. A method of protecting a user from flying debris and other contaminants in a workplace environment, the method comprising the steps of:
providing a face mask shield device comprising a protective mask component that fully encapsulates a nose, mouth, eyes and ears of the user and a battery;
securing the face mask shield device to a user's face area;
securing a detachable respirator filter and detachable earmuffs to the face mask shield device as needed;
utilizing the face mask shield device in a hazardous material environment; and
recharging the battery after use of the face mask shield device as needed.
